(19) United States
(12) Patent Application Publication
(10) Pub. No.: US 2021/0298411 A1
(43) Pub. Date: Sep. 30, 2021

(54) AN ARTICLE OF FOOTWEAR

(71) Applicant: ECCO SKO A/S, Bredebro (DK)

(72) Inventors: Frank Jensen, Bredebro (DK); Jakob Moller Hansen, Bredebro (DK)

(21) Appl. No.: 17/268,317

(22) PCT Filed: Aug. 14, 2019
(86) PCT No.: PCT/EP2019/071854

§ 371 Date: Feb. 12, 2021

(30) Foreign Application Priority Data
Aug. 15, 2018 (EP) 18189131.8
Dec. 5, 2018 (EP) 18210343.2

(51) Int. Cl. A43B 7/12; A43D 25/18

(52) U.S. Cl. CPC A43B 7/125; A43D 25/18

(57) ABSTRACT

An article of footwear includes an upper assembly having a foot insertion volume. The foot insertion volume includes a proximal part and a lateral part. A first layer and a second layer each have a lateral surface and a medial surface, respectively. The second layer is positioned between the foot insertion volume and the medial surface of the first layer. A sole assembly includes an upper facing surface and a ground contacting surface. The upper facing surface is connected to the proximal part of the upper assembly. A peripheral part of the sole assembly overlaps a proximal part of the first outer layer and/or the second layer. The first outer layer includes a through-going opening extending from the lateral surface and towards the medial surface. A part of the overlapping material of the sole penetrates the opening to bond to the second layer.

### FIELD

An article of footwear comprising: an upper assembly having a longitudinal axis extending from a heel area of the upper towards the forefoot area of the upper, the upper assembly comprising a foot insertion volume, where the foot insertion volume comprises a proximal part and a lateral part that extends from the proximal part and in a vertical direction upwards away from the proximal part, a first layer having a lateral surface and a medial surface, a second layer having a lateral surface and a medial surface.

### BACKGROUND

The manufacturing of footwear produces a vast number of different types of footwear, where each shoe, boot, sandal and/or slipper may have a certain predefined function, where the design, shape, construction of the article of footwear may be specifically adapted for that function. E.g. a hiking boot has vastly different construction and shape than for example a running shoe.

For certain types of footwear, it may be important to provide an article that is waterproof, i.e. ensuring that water that surrounds the shoe does not penetrate the inner volume of the upper, and therefore keeps the foot of the wearer dry during use. However, there are a number of ways to achieve this, i.e. by providing a liquid and vapour impermeable article of footwear that prevents water molecules to penetrate the article of footwear. This however has the downside that any liquid or moisture inside the article of footwear is not capable of exiting the footwear, which means that if the foot of the wearer sweats, the sweat remains inside the footwear during use.

One solution to this problem is to provide a layered construction of an upper of an article of footwear, where one of the layers may be permeable to vapour and/or liquids, while another layer is liquid impermeable, while still being vapour permeable. This type of layer may be called a functional layer, which is e.g. provided by a manufacturer like WL Gore, in the form of a Gore-Tex material, which is a layered material, having pores that are large enough for water vapour molecules to penetrate, while having small enough pores so that liquid molecules cannot penetrate, and thus are vapour permeable and liquid impermeable layers.

The functional layers may be provided on the upper, where the functional layer may be positioned between the inner volume of the upper, i.e. the foot insertion volume, and an outer layer of the shoe, such as a textile layer, leather layer or other suitable layers that are adapted to be the outermost layer of the footwear.

The functional layer is a relatively expensive material when designing articles of footwear, where the traditional way of ensuring the liquid impermeability of the shoe is to enclose most of the foot insertion space of the footwear with a functional layer in order to ensure that liquids cannot penetrate. This provision of the functional layer increases the material cost of the manufacturing of the article of footwear, as the cost of the functional layer in view of the rest of the material cost is relatively high.

U.S. Pat. No. 4,899,465 discloses a waterproof footwear, where the upper has a porous portion in the connecting region with the insole. During injection molding of the sole, liquid caoutchouc or plastic material passes through the openings of the porous portion of the upper onto the laminate. The plastic sole material which is then present between the laminate and the upper seals the seam holes in the functional layer. Thus, there is a need to provide an article of footwear that reduces the need for the functional layer, while still providing a liquid impermeable and vapour permeable article of footwear.

### GENERAL DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

In accordance with the invention, there is provided an article of footwear comprising: an upper assembly having a longitudinal axis extending from a heel area of the upper towards the forefoot area of the upper, the upper assembly comprising a foot insertion volume, where the foot insertion volume comprises a proximal part and a lateral part that extends from the proximal part and in a vertical direction upwards away from the proximal part, a first layer having a lateral surface and a medial surface, a second layer having a lateral surface and a medial surface, where the second layer is positioned between the foot insertion volume and the medial surface of the first layer, the article of footwear further comprising a sole assembly comprising an upper facing surface and a ground contacting surface, where the upper facing surface is connected to the proximal part of the upper assembly and where a peripheral part of the sole assembly overlaps a proximal part of the first outer layer and/or the second layer where the first outer layer of the upper assembly and/or the second layer comprises at least one through-going opening extending from the lateral surface and towards the medial surface, where a part of the overlapping material of the sole penetrates the opening and where the material of the sole bonds to the second layer providing a waterproof seal between the sole material and the second layer optionally where the first layer abuts the second layer in the region where the peripheral part of the sole assembly overlaps the proximal part of the first layer and/or the second layer.

This construction may be utilized where the first layer of the upper may be an aesthetically pleasing material, such as a leather material, canvas material, knitted polymer, or other types of materials that are utilized for footwear manufacturing and give the article of footwear a specific desired look. These materials are often liquid permeable materials that give the article of footwear their characterizing look or have a specific function, such as low weight, colour, stiffness, elasticity, or other types of desired capabilities.

The provision of a second waterproof and vapour permeable layer, where the bonding between the outsole and the second layer may be provided via through going openings, means that the bonding between the sole material and the second layer via the opening may ensure that water in liquid form cannot pass in direction from the first layer and into the foot insertion volume via the seal. The sole material may be chemically bonded to the second layer so that the specific area of the second layer, e.g. the medial or the lateral side, where the seal is present will ensure that the liquid cannot pass into the foot insertion volume, and thereby ensure that the liquid will not enter the article of footwear through the second layer or proximally past the second layer in the area where the sole material is bonded to the second layer.

This construction means that the amount waterproof and vapour permeable functional second layer may be reduced, as the layer only has to extend into an area of the upper assembly where the sole assembly is attached and/or bonded to the upper assembly. Thus, the waterproof seal may be provided in a side area of the footwear, on a medial side of the area where the outsole intersects the upper. By moving the proximal edge of the second layer close to where the lateral edge sole assembly intersects the upper, it is possible to reduce the amount of material that is used to manufacture a waterproof and vapour permeable shoe, i.e. item of footwear, and thereby reduce the manufacturing cost of each item of footwear significantly. Thus, the waterproof and water permeable layer only covers a small part of the upper where the upper facing surface of the sole assembly encloses the proximal part of the the upper assembly, as the seal between the sole material and the second layer prevents liquids from penetrating the foot insertion volume in the proximal part of the upper assembly.

Furthermore, by providing a seal between the sole material and the second layer it is possible to manufacture the upper assembly, where the amount of material for the first layer and the second layer is approximately equal, where the proximal ends of the two layers terminate approximately equadistally above the sole assembly. Generally, the sole assembly or the material of the sole assembly bonds with the outermost layer of the upper assembly, in its proximal position, creating the outsole of the footwear, by applying the present invention the outsole can bond both to the proximal part of the outermost layer and the second waterproof and breathable second layer.

The through going opening in the first and/or the second layer may be positioned in an area of the first and/or the second material where the upper facing surface of the sole assembly overlaps the proximal part of the upper assembly.

In accordance with the present disclosure, the terms proximal and distal may be defined with regards to bottom of the article of footwear. I.e. that the outsole or the ground contacting surface of the footwear define boundary of the proximal and distal terms. This means that a proximal part is close to the ground contacting surface, while a part that is distal may be defined as being a distance away from the ground contacting surface. Similarly, the terms medial and lateral, may be used to define parts relative to the foot insertion volume, or a central imaginary point inside the article of footwear. I.e. a medial surface of a layer may be the surface of the layer that faces the point or the foot insertion volume, while the lateral surface may be the surface facing away from the point or the foot insertion volume.

The through going opening in the first and/or second layer may be in the form of a cut out of a small part of the material of the first and/or second layer, or it may alternatively be created by a penetrating device, such as a needle that penetrates the one or more of the layers of the upper assembly. By utilizing a device such as a needle, the penetration of the layers may be utilized to fix the layers to each other by stitching, or alternatively that the stitching may be utilized to attach a different element to the upper assembly, such as an insole, a lining, or other layers that may be advantageous in an upper assembly and materials that might be known to a person skilled in the art of shoe manufacturing.

The bonding between the second layer and the sole material may be a chemical bond, where the sole material is directly bonded to the second layer, or the bond may be applied via an intermediate layer of an adhesive, where the adhesive adheres and/or improves the bond between the sole material and the second layer.

The bonding of the sole material to the second layer may occur on the lateral side of the second layer and/or the proximal side of the second layer. In some embodiments the sole material does not penetrate the second layer, but bonds to a lateral side of the second layer. In some embodiments the sole material may penetrate the second layer via a through-going opening, and where the sole material is configured to bond to the medial side of the second layer and/or the surface area of the through-going opening. In some embodiments the sole material may be adapted to bond to both the lateral side of the second layer as well as the medial side of the first layer. The bond between the sole material and the second layer may be provided as a waterproof and/or vapour proof seal, so that liquids and/or vapour may be prevented in passing between the sole material and the second layer.

By providing a footwear assembly or an article of footwear where the first layer abuts the second layer in the region where the outsole overlaps the first layer and the second layer, it may be ensured that the material of the sole assembly does not distort the upper assembly during manufacturing. This may mean that a surface area of the first layer may be in contact with a surface area of the second layer prior to the provision of the sole material, and optionally also after the provision of the sole material. Thus, the construction may be adapted to prevent sole material to penetrate the region where the first layer abuts the second layer. If the sole material is allowed to penetrate the region/volume between the first layer and the second layer, the sole material may distort the positioning of the first layer relative to the second layer, and either push the first layer in a lateral (outwards) direction and/or the second layer in a medial (inwards) direction. If this occurs the article of footwear may have a shape that is unwanted and unpredictable by the designers of the article of footwear. The abutment of the first layer to the second layer may be obtained in various means, e.g. by arranging the upper assembly on a last, where the tension of the first layer and the second layer is sufficient to prevent sole material to enter the region between the first layer and the second layer, so that the sole material only penetrates the opening in the first and/or the second layer to bond with the second layer. Another way of obtaining this may be to provide a permanent or temporary adhesion between the first layer and the second layer, so that the sole material penetrates the opening in the first and/or the second layer, and does not penetrate the region between the first layer and the second layer. Another way of obtaining this may be to utilize a direct injection mould as well as a direct injection last during the manufacturing of the sole assembly, to press the first layer to the second layer, or vice versa, to prevent sole material to penetrate the region between the first layer and the second layer.

The penetration of the sole material into the openings in the first layer and/or the second layer may be adapted to fix the first layer to the second layer and/or the second layer to the first layer, where the sole material may be adapted to bond to the second layer, where the sole material may abut the first layer so that the sole material may press or wedge the first into contact with the second layer. During direct injection, the openings of the first and/or the second layer may be in fluid communication with the mould cavity which means that the expanding of the sole material will ensure that the sole material will penetrate the opening and come into contact with the second layer, to bond with the second layer, and when the sole material cures, the sole material may remain bonded to the second layer where the sole material in the overlapping region may maintain the contact with an outer surface of the first layer and thereby press the first layer into abutment with the second layer.

Within the meaning of the present disclosure, the term “abut” may mean that a first element disclosed as abutting may be next to the second element. I.e. that the layers are next to each other, or are adjacent to each other. The term may mean that if one element abuts another element, the two elements may be arranged in such a manner that the elements face each other. The term abut does not preclude that there may be an additional element between the first and the second element, such as an adhesive layer, where the adhesive layer may attach the first element to the second element, where the adhesive element may have a negligible effect on the thickness of the layered structure.

In one exemplary embodiment, the distance between a surface area of the first layer and a surface are of the second layer is less than 2 mm in the region where the sole assembly overlaps the first and/or the second layer. The distance is preferably less than 1 mm, or where the distance is less than 0.5 mm. By providing a small distance between the two layers it is possible to prevent the sole material to penetrate the region between the first layer and the second layer. In one exemplary embodiment, the medial surface of the first layer may abut the lateral surface of the second layer in the region where the peripheral part of the sole assembly overlaps the proximal part of the first layer and/or proximal part of the second layer. Thus, the medial surface of the first layer and the lateral surface of the second layer face each other, and are adjacent to each other. This may mean that the sole material does not penetrate the region between the medial surface of the first layer and the lateral surface of the second layer.

In one or more exemplary embodiments the sole material does not penetrate parts of the region between the first layer and the second layer in the region where the sole material overlaps the first layer and/or the second layer. Thus, the sole material will not be present in parts of and/or all of the regions where the sole material overlaps the first and/or the second layer. Thus, the sole material will not deform the shape of the upper assembly, by penetrating the region between the two layers.

In one or more embodiments, the sole material may penetrate the opening in the second layer and providing a waterproof inner seal on the medial side of the second layer in order to ensure that liquids cannot enter or exit the foot insertion volume via the opening in the second layer. By having the sole material to penetrate the opening in the second layer, and penetrate the opening from the lateral side and towards the medial side, so that the opening in the second layer is closed off, and preventing that liquids can pass the opening from the medial side to the lateral side or vice versa via the opening. The material of the sole may penetrate the opening from a lateral side, extend through the through going opening and exit the layer on the medial side, where the sole material may expand to a size that is larger than the diameter of the opening and thereby create a plug or a filling on the medial side, where the diameter of the sole material on the medial size is larger than the diameter of the sole material inside the through going opening. The material that is on the medial side of the layer may be configured to bond to the medial side of the second layer, in the area of the medial side of the second layer that abuts the opening, so that liquids that cannot escape the opening on the medial side between the sole material and the medial side of the second layer.

The through-going opening in more than one layers may be coaxial, so that the openings create a fluid communication towards the second layer allowing the sole material to come into contact with the second layer.

In one or more embodiments, the inner seal may extend from the opening and in distal direction along the medial side of the second layer, where the inner seal optionally extends from the opening and in a proximal direction along the proximal part of the foot insertion volume. This means that the inner seal may extend a distance upwards and/or downwards along the medial surface area of the second layer or possibly a further layer that may be arranged between the medial surface of the second layer and the foot insertion volume. The height of the inner seal may improve the adhesion of the inner seal to an medial side of a layer, and thereby increase the area where the inner seal is bound to the medial side of the upper assembly, and thereby reduce the chance that the inner seal may leak when the article of footwear is in an environment.

The manufacturing of the inner seal may be provided by designing a last for introduction into the foot insertion volume, that may be provided with a gap in its outer surface, creating a volume in the area which abuts the through-going opening in the first and/or the second layer, so that when the sole material expands from the outside of the upper assembly and penetrates the through going opening, it is allowed to fill up the gap in the last, so that gap in the last creates a moulding volume for the inner seal of the sole material.

In one or more embodiments, the upper facing surface may terminate in a lateral end that extends in a radial direction away from a central point of the sole assembly. Thus, the upper facing surface of the sole assembly may have a peripheral edge, that surrounds the upper assembly in a proximal part, creating lateral edge of the sole assembly, which may be in the form of a lateral wall of the sole assembly. The lateral wall of the sole assembly may extend from the upper facing surface to the ground contacting surface. The lateral wall may extend in a circumferential manner, so that the lateral end of the sole material may be on the medial side, lateral side, heel side and toe side of the upper assembly, and may be in all areas between the aforementioned sides. I.e. the lateral wall of the sole assembly may be unbroken along the entire circumference of a proximal part of the upper assembly.

In one or more embodiments, the first layer and the second layer may be attached to each other via at least one stitch, optionally a strobel stitch. The stitching may be utilized to provide the through-going opening from the medial side to the lateral side of one or more of the layers, allowing the sole material to penetrate the opening that was created when a needle has penetrated one or more of the layers. The thread used for the stitching may have a cross sectional diameter that may be smaller than the cross sectional diameter of the needle, so that when the thread has been introduced into the opening created by the needle, there may be a free volume inside the opening, allowing the sole material to penetrate the through-going opening and fill up the volume that is not filled by the thread.

The thread that may be utilised for the stitching (strobel stitch) may be any kind of suitable thread. In one or more embodiments, the thread may be of the kind where the stitch is liquid impermeable, i.e. where the stitch cannot wick liquids from one side of the layer to the opposite side of the layer via the opening. Such a thread may e.g. be a nylon thread, or a weaved thread that may be surface coated or treated in such a way that the thread cannot transfer liquids.

In one or more embodiments, the stitching may be close to the proximal end of the first and/or the second layer. Thus, when the stitching is close to the proximal end of the first and/or the second layer, the stitches may be in an area where the sole assembly overlaps the upper assembly, allowing the sole material to penetrate the holes made by the stitching of the layers.

In one or more embodiments, the upper assembly may further comprise a connecting portion adapted to connect the proximal portion of the upper assembly to the first and/or the second layer. The connecting portion may be in the form of a textile material, net material, mesh material, or any type of material that allows the proximal portion of the first and/or the second layer to be connected to a proximal part of the upper assembly. The connecting portion may be in the form of an insole having a peripheral edge, where the peripheral edge of the connecting portion is connected to the proximal end of the first and/or the second layer of the upper assembly and/or further layers of the upper assembly, if the upper assembly comprises more than two layers.

The connecting portion may be provided in the form of a material that is permeable to the sole material, so that when the sole assembly is applied to the upper, the material of the sole penetrates the connecting portion. The penetration of the sole material into the connection portion, may ensure that the liquids cannot pass into or out of the foot insertion volume of the upper assembly via the connecting portion. I.e. when the sole assembly has been bonded to the connection portion, the bond may be waterproof.

In one or more embodiments, the connecting portion may extend a distance in a radial direction outward from a central point of the upper assembly towards a radial part of the upper assembly, where the connecting portion overlaps the upper facing surface of the sole assembly in a lateral direction in a range between 50% and 99%. By providing a connecting portion that extends in a lateral distance and outwards in the range between 50-100% of the upper facing surface of the sole assembly, it is possible to provide a connecting portion that overlaps at least more than 50% of the area of the upper facing surface. The closer the overlap is close to a 100%, it may be possible to reduce the use of the second layer, as the second layer may is an expensive material, compared to the remaining layers of the upper assembly. Thus, when the connecting portion overlaps most of the upper facing surface of the sole assembly, and the proximal end of the second layer is attached to a lateral end of the connecting portion, the second layer only has to pass the lateral edge or wall of the sole assembly, in order to allow the sole material to penetrate the through going opening and create a waterproof bond between the sole material and the second layer.

In one or more embodiments, the second layer may be a waterproof and vapour permeable functional layer. A waterproof and vapour permeable functional layer is well known within the art, such as commercially available GORE-TEX<®> laminate from W. L. Gore & Associates. The functional layer, may comprise a single layer of material, or may comprise two or more layers of materials that are provided in a laminate, creating a functional layer assembly. The second layer may be in the form of any layer, or a laminate of layers that create a waterproof and vapour permeable layer for the upper assembly. The vapour permeability of the layer may be adjusted in accordance with the specific use of the footwear, so that for some uses the vapour permeability may be greater than other uses, such as a hiking boot versus a casual shoe.

In one or more embodiments, the second layer may abut the first layer. The second layer may be bonded or attached directly to the first layer, so that the lateral surface of the second layer abuts the medial surface of the first layer. Thus, if the through-going opening is provided in the first layer, the sole material may penetrate the opening, and bond to the second layer via the opening in the first layer.

In one or more embodiments, the upper assembly may be provided with three or more layers, where the first layer and the second layer are only a part of the multiple layered upper assembly.

In one or more embodiments, the first layer may be an outermost layer of the upper assembly. The first layer may be a textile layer, a leather layer, a nubuck layer, a knitted layer, or any type of layer that may be used as the outermost layer of a footwear upper, where the first layer may provide the outer appearance of the footwear. The first layer may be provided as a layer that may be liquid and/or vapour permeable, as any liquids that can pass the first layer, are prevented from entering the foot insertion volume by the second layer.

In one or more embodiments, the sole assembly may be injection moulded, optionally where the sole assembly is direct injection expanded foam moulding. Direct injection expanded foam (DIP) moulding may be very useful when the upper assembly is provided with a plurality of openings, as the expanding foam will penetrate all volumes of the upper assembly that are accessible via the mould cavity. On the opposite side of the mould cavity, the foot insertion volume of the upper assembly may be provided with a last, that provides a counter mould for the expanding foam, and thereby preventing the foam to penetrate the volume of the last, i.e. that the mould does not expand past the outer surface of the last. The last may be provided with surface areas that allow the sole material to penetrate areas that may be in between the outer surface of the last and the inner surface of the upper assembly, in order to provide functional features to the article of footwear, such as the inner seal, and/or structural elements to improve comfort or structural integrity of the article of footwear.

In one or more embodiments, the material of the sole assembly may be a polymer material, optionally a polyurethane (PU), optionally a thermoplastic polyurethane (TPU), or a multi component sole assembly comprising different parts of polymeric materials having different properties. Furthermore, the material of the sole assembly may be leather, to provide a specific aesthetic look, a shank to add stiffness to the sole, as well as other pre-manufactured pieces that are intended to provide an aesthetic or structural function. In addition, a multi component sole assembly may have polymeric materials that may have different density, elasticity, stiffness, wear resistance, or other properties, in order to provide the desired type of footwear.

In one or more embodiments, the at least one through going opening, may be a plurality of through going openings positioned on a proximal end of the first and/or the second layer. Thus, the openings may be provided in more than one area of the proximal end of the first and/or the second layer in order to allow the sole material to bond to the second layer in different positions of the footwear article. Thus, the through-going openings may be provided in any of a forefoot area, heel area, lateral area, medial area or any areas between the aforementioned areas.

In one or more embodiments, the plurality of through going openings may be arranged in a linear manner, creating one or more rows of through going openings in the first and/or the second layer. Thus the openings may be provided as a plurality of openings that are arranged on a proximal end of the first and/or the second layer, creating a row of openings where the sole material penetrates the layer and bonds with the second layer in a waterproof seal. The through-going openings may be provided in two or more substantially parallel rows along the proximal end of the first and/or the second layers. In one or more embodiments, on row may be offset relative to another row, so that an opening in one row is distal in a vertical direction to the gap between two openings in the adjacent row, to improve the water impermeability between the first and the second layer, and reducing the area where the water may penetrate in a proximal direction downwards past the openings.

In one or more embodiments, the waterproof seal may extend continuously along the entire proximal part of the second layer. This means that the waterproof seal is capable of preventing water to penetrate the foot insertion volume of the article of footwear in an area that is lateral to the proximal end of the second layer. The waterproof seal ensures thereby that the entire proximal end of the second layer is bonded to the sole material, so that there are no areas where water can pass past the waterproof seal via the opening or the proximal end of the second layer.

### BRIEF DESCRIPTION OF THE DRAWINGS

FIG. 1 shows a sectional view of an article of footwear, having an upper assembly and a sole assembly,

FIGS. 2a and 2b, shows a sectional view of a part of an article of footwear,

FIGS. 3a and 3b, shows a sectional view of a part of an article of footwear, and

FIGS. 4a and 4b show a side view of an upper, having one and two rows of through-going openings.

### DETAILED DESCRIPTION

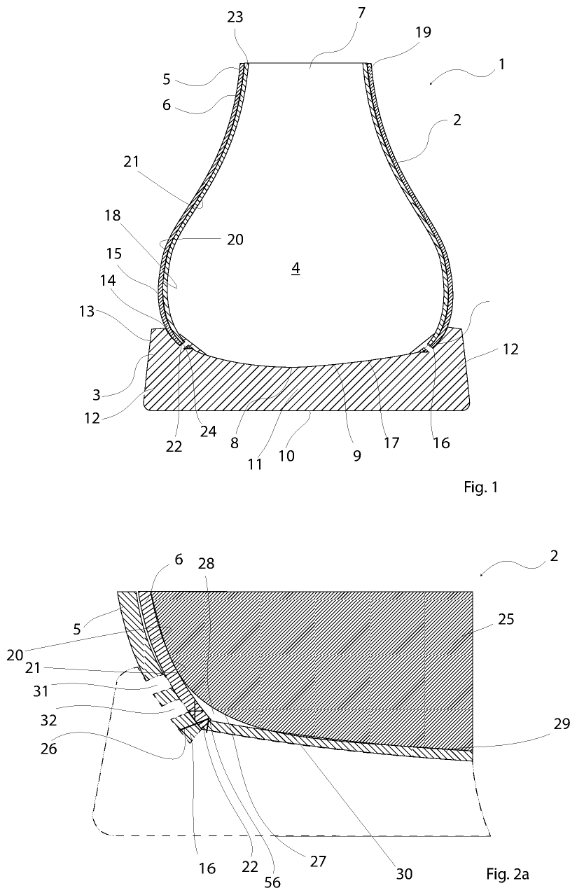

FIG. 1 shows a sectional view of an article of footwear 1, such as a shoe, comprising an upper assembly 2 and a sole assembly 3, where the upper assembly comprises a foot insertion volume 4. The upper assembly 2 comprises a first layer 5 and a second layer 6, where the first layer 5 is the outer layer of the upper assembly 2, and the second layer 6 is positioned between the first layer 5 and the foot insertion volume 4, in a radial direction away from the point A.

The upper assembly 2 has a proximal part 7 and a distal part 8, where the proximal part abuts the upper facing surface 9 of the sole assembly 3. The sole assembly further has a ground contacting surface 10, which is intended to come into contact with the ground when the article of footwear 1 is worn by a user. In accordance with one or more embodiments, the sole assembly may be a midsole, where the ground contacting surface 10 may be an outsole facing surface, in case there is an outsole applied between the midsole and the ground, or any other form for a sole part located between the ground and the midsole. Thus, the term ground contacting surface may be replaced by the term ground facing surface.

The sole assembly has a medial part 11 and opposing lateral parts 12, where the lateral parts may comprise a lateral wall 13, that extends from the upper facing surface 9 and towards the ground contacting surface 10. The upper facing surface 9 may have a peripheral edge 14 that abuts the outer surface 15 (lateral surface) of the first layer 5, and the part of the upper facing surface 9 that overlaps the first layer 5 may be bonded to the outer surface (lateral surface) 15 of the first layer. The first layer has a proximal end 16 that extends past the peripheral edge 14 of the upper surface, and extends in a proximal direction towards the bottom 17 of the upper assembly, and terminates in an area where the upper assembly 2 and the sole assembly 3 are joined.

The first layer 5 further comprises a medial surface 18 that faces the foot insertion volume 4 of the upper assembly 2, and a distal end 19. The second layer comprises a lateral surface 20 and a medial surface 21, as well as a proximal end 22 and a distal end 23. The lateral surface 20 of the second layer 6 abuts the medial surface 18 of the first layer 5, where the medial surface 21 of the second layer 6 faces the foot insertion volume 4 of the upper assembly 2. The upper assembly 2 may comprise more than two layers, where a third, fourth or subsequent layers may be provided. The second layer 2 however should be positioned between the foot insertion volume and the outermost layer of the upper assembly, in order to prevent liquids to enter the foot insertion volume.

The upper assembly may be provided with a through going opening 24, which may be positioned in the first layer 5 and/or the second layer 6, close to the proximal ends 16, 22 of the two layers, where the opening provides a fluid communication, prior to the application of the sole assembly 3, to the lateral surface 20, the medial surface 21 and/or the proximal end 22 of the second layer, allowing the sole material to penetrate the opening and bond with the second layer 6, creating a waterproof bond between the sole material and the second layer 6.

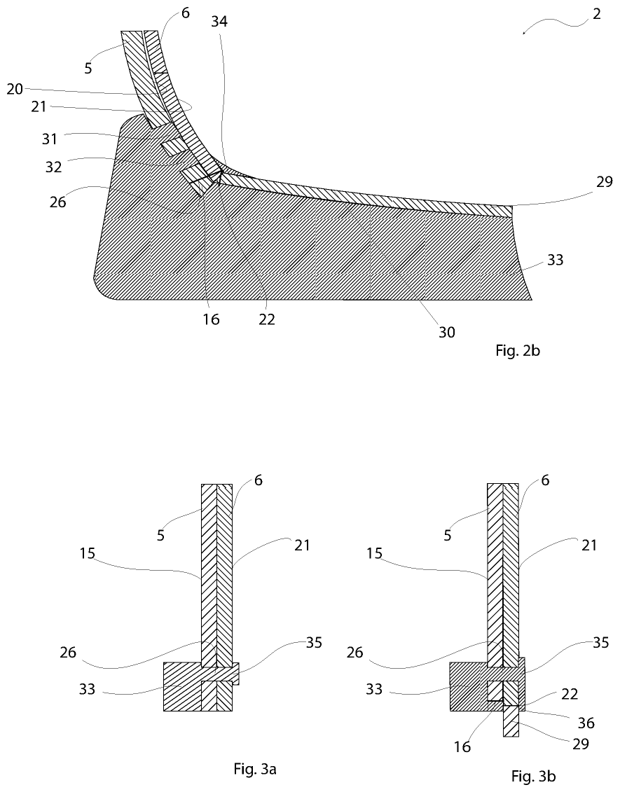

FIG. 2a shows the upper assembly 2, prior to the application of the sole assembly, where a last 25 has been introduced into the foot insertion volume 4 (shown in FIG. 1) of the upper assembly. The proximal end 16 of the first layer 5 and the proximal end 22 of the second layer 6 are provided with a through going opening 26, which penetrates both layers 5, 6 and provides a fluid communication into the foot insertion volume 4 of the upper assembly 2. The last 25 is provided with an area 27 that creates a volume 28 inside the foot insertion volume 4, where the boundaries of the volume 28 are the medial surface 21 of the second layer, the outer surface of the last 25 and a distal surface 30 of a connecting portion 29. The volume 28 is in fluid communication with the opening 26, where sole material can penetrate the opening, and enter the volume 28.

The first layer 5 is further provided with a first through-going opening 31 and a second through-going opening 32, that are positioned in the vicinity of the proximal end 16 of the first layer 6, where the openings provide a fluid communication to the lateral surface 20 of the second layer 6, allowing the sole material to penetrate the openings 31 and 32 to come into contact with lateral surface 20

The result of the application of the sole assembly 3 is shown in FIG. 2b, where the last 25 has been removed, and the sole material 33 has penetrated the volume 28, via the through going opening 26, to create an inner seal 34 that is bonded to the medial surface 21 of the second layer 6, as well as penetrating the openings 31 and 32, to create a waterproof bond between the sole material 33 and the lateral surface 20 of the second layer 6. The inner seal may extend upwards (distal direction) along the medial surface 21 of the second layer, ensuring that liquids cannot pass the inner seal 34 in a direction towards the foot insertion volume. The inner seal 34 may extend along the entire circumference of the proximal end 22 of the second layer 6, ensuring that liquids cannot pass into the foot insertion volume via the opening 26.

The connecting portion 29 may be of the kind which creates a watertight seal between the connecting portion 29 and the sole material, so that the sole material can seal the abutting proximal end 22 of the second layer, ensuring that liquids cannot pass into the foot insertion volume via the connecting portion 29. This may occur where the sole material may provide a waterproof seal between the connecting portion and the sole material, where a bond occurs on the proximal and/or the distal surface area of the connecting portion, or where the sole material may penetrate the connecting portion 29 , to fill up all open volumes of the connection portion 29, if there are any.

The sole material 33 also penetrates the first 31 and the second 32 through-going openings in the first layer 6, so that the sole material bonds with the lateral surface 20 of the second layer. The bond ensures that liquids cannot pass in a medial direction past the bond, and that liquids cannot pass through the first layer in the area of the bond.

The embodiment shown in FIG. 2a, is an exemplary embodiment, showing a plurality of the through going openings 26, 31 and 32 in a single cross section of the shoe, on one side of the shoe. In other embodiments, showing a cross section of a shoe, the upper assembly may have one, two, three, or further numbers of openings, where the through-going openings may be in the first layer, the second layer, both layers. The bond may be on any part of the second layer, provided that it is in an area where the sole assembly overlaps the proximal part of the upper assembly.

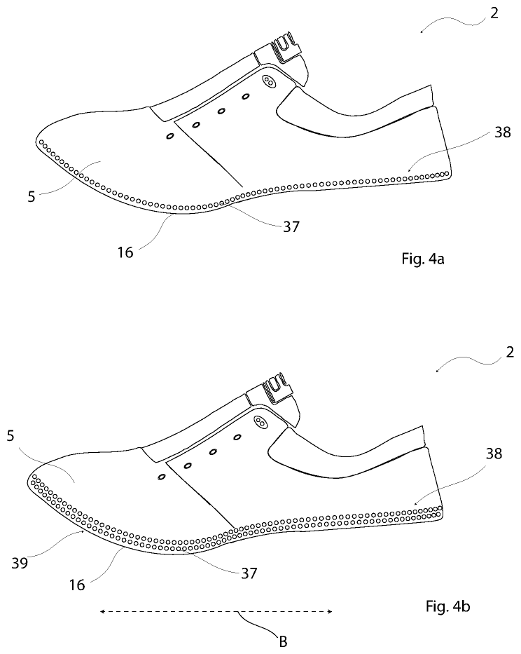

FIG. 3a shows a cross sectional view of a first layer 5 and a second layer 6, where there is a through-going opening 26 through both layers, allowing a fluid communication from the lateral side 15 of the first layer 5 to the medial side 21 of the second layer 6. The sole material 33, extends through the opening 26, and terminates on the medial side 21 of the second layer 6, where the medial part 35 of the sole material, has an increased diameter, so that the medial part covers an area on the medial side 21 that is larger than the opening 26.

FIG. 3b shows a similar cross sectional view, where the proximal end 16 of the first layer 5 and the proximal end 22 of the second layer 6 terminate at different proximal positions. The proximal end 22 of the second layer 6 is connected to a connecting portion 29. The medial part 35 may extend in a proximal direction and past the joint 36 between the connecting portion 29 and the proximal end 22, so that liquids cannot enter or exit the joint 36 in a medial or lateral direction.

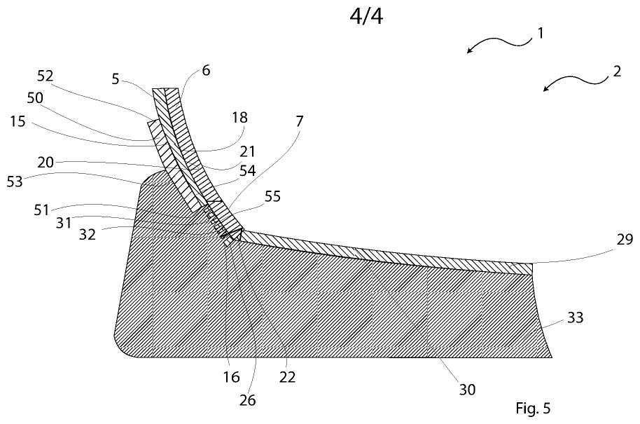

FIGS. 4a and 4b show an upper assembly 2, where the proximal end 16 of the first layer 5 are provided with a plurality of through-going openings 37, where the openings are arranged in a linear manner 38, along the entire perimeter of the proximal end 16 of the of the first layer 5. FIG. 4a, shows an upper assembly having only one row 38 of openings 37, where FIG. 4b shows an upper assembly having two adjacent rows 38, 39, of openings. The openings may be positioned offset 37 in the longitudinal direction B, in one row, so that one opening in the upper row 39 is directly above a gap between two openings 37 in the lower row 38, or vice versa.

FIG. 5 shows a sectional view of a part of an article of footwear 1, having an upper assembly 2 comprising a second layer 6 and a first layer 5, where a third layer 50 has been attached to the first layer 5. The third layer 50 may in some areas be the outermost layer of at least part of the upper assembly 2. In this embodiment the third layer is positioned as the outermost layer at a proximal part 7 of the upper assembly 2. The proximal end 51 of the third layer 50 and the distal end 52 of the third layer 50 may be attached to the first layer 5 via a stitching, where the third layer 50 may e.g. be seen as a decorative layer, or a layer a specific function to the upper assembly, such as an increased durability, strength, etc. The medial side surface 54 of the third layer 50 may therefore be attached to the lateral surface 15 of the first layer 5.

The first layer 5 in this embodiment, may be provided as a perforated layer, where the perforations in the first layer 5 may be seen as openings 31, 32 that allow fluid communication from the lateral side 15 of the first layer 5 to the medial side 18 of the first layer, where the perforations 31,32 are dimensioned in such a manner, that they allow the sole material 33 , to penetrate the perforations and come into contact with the lateral surface 20 of the second layer 6, creating a seal 55 between the sole material 33 and the lateral surface 20, and thus ensuring that liquids cannot pass the sole material and the lateral surface. The first layer 5 may be attached to the connecting portion 29 using the same strobel stitch 22 which connects the connecting portion to the second layer.

Thus, the sole material 33 may attach to all three layers 5, 6, 50 in that the sole material may attach to the lateral surface 53 and the proximal end 51 of the third material 50, to the surface area of the perforations 31, 32 and the lateral surface 15 of the first material 5, as well as the lateral surface 20 of the second material 6. The proximal end 51 of the third material 50, may terminate prior to the proximal end 26 of first layer 5 and/or the proximal end 22 of the second layer 6, i.e. where the first and second layer extend a longer distance in a medial direction toward the centre of into the upper facing surface 9 of the sole assembly 3.

Within the scope of the present invention the first layer 5, may extend from a distal portion 23 of the upper assembly 2 and towards the proximal portion 7 of the upper assembly 2 (as seen in FIG. 1), where the layer as a whole may be perforated, and present an outer layer of the shoe, which may be seen as perforated. One example of such material may be a knitted layer, having a low stitch density, allowing the material of the sole assembly to penetrate between the stitching, or a textile layer having a perforated structure which allows the sole material to penetrate from its distal surface towards its lateral surface of the perforated layer.

Within the concept of the present invention, a perforated first layer having through going openings and/or perforations that allow sole material to penetrate, may be attached to a connecting portion via a stitching. Another example could be to provide the first layer where the first layer is laminated to the second layer, creating a structure where the medial surface of the first layer is laminated to the lateral surface of the second layer, but where the perforations (through going openings) allow the sole material to penetrate, and come into contact to the lateral surface of the second layer via the perforations and/or openings and bond to the lateral surface of the second layer.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### ITEMS

1. An article of footwear comprising
   an upper assembly having a longitudinal axis extending from a heel area of the upper assembly towards the forefoot area of the upper assembly, the upper assembly comprising
      a foot insertion volume, where the foot insertion volume comprises a proximal part and a lateral part that extends from the proximal part and in a vertical direction upwards away from the proximal part,
      a first layer having a lateral surface and a medial surface,
      a waterproof and vapour permeable functional second layer having a lateral surface and a medial surface, where the second layer is positioned between the foot insertion volume and the medial surface of the first layer,
   a sole assembly comprising an upper facing surface and a ground contacting surface, where the upper facing surface is connected to the proximal part of the upper assembly and where a peripheral part of the sole assembly overlaps a proximal part of the first layer and/or the second layer,
      where the first layer of the upper assembly and/or the second layer comprises at least one through-going opening extending from the lateral surface and towards the medial surface, where a part of the overlapping material of the sole penetrates the opening and where the material of the sole bonds to the second layer providing a waterproof seal between the sole material and the second layer.
2. An article of footwear in accordance with item 1, wherein the sole material penetrates the opening in the second layer and providing a waterproof inner seal on the medial side of the second layer in order to ensure that liquids cannot enter or exit the foot insertion volume via the opening in the second layer.
3. An article of footwear in accordance with item 2, wherein the inner seal extends from the opening and in distal direction along the medial side of the second layer, where the inner seal optionally extends from the opening and in a proximal direction along the proximal part of the foot insertion volume
4. An article of footwear in accordance with any one of the preceding items, where the upper facing surface terminates in a lateral end (edge) that extends in a radial direction away from a central point of the sole assembly.
5. An article of footwear in accordance with any of the preceding items wherein the first layer and the second layer are attached to each other via at least one stitch, optionally a strobel stitch.
6. An article of footwear in accordance with any of the preceding items where the upper assembly further comprises a connecting portion adapted to connect the proximal portion of the upper assembly to the first and/or the second layer.
7. An article of footwear in accordance with item 5 where the connecting portion extends a distance in a radial direction outward from a central point of the upper assembly towards a radial part of the upper assembly, where the connecting portion overlaps the upper facing surface of the sole assembly in a lateral direction in a range between 50% and 99%
8. An article of footwear in accordance with any one of the preceding items, wherein the second layer abuts the first layer.
9. An article of footwear in accordance with any one of the preceding items, wherein the first layer is an outermost layer of the upper assembly.
10. An article of footwear in accordance with any one of the preceding items, wherein the sole assembly is injection moulded, optionally where the sole assembly is direct injection expanded foam moulding.
11. An article of footwear in accordance with any one of the preceding items, wherein the material of the sole assembly is a polymer material, optionally a polyurethane (PU), optionally a thermoplastic polyurethane (TPU), or a multi component sole assembly comprising different parts of polymeric materials having different properties.
12. An article of footwear in accordance with any one of the preceding items, wherein the at least one through going opening, may be a plurality of through going openings positioned on a proximal end of the first and/or the second layer.
13. An article of footwear in accordance with item 12, wherein the plurality of through going openings may be arranged in a linear manner, creating one or more rows of through going openings in the first and/or the second layer.
14. An article of footwear in accordance with any one of the preceding claims, wherein the waterproof seal extends continuously along the entire proximal part of the second layer.

1. An article of footwear comprising:
an upper assembly having a longitudinal axis extending from a heel area of the upper assembly towards a forefoot area of the upper assembly, the upper assembly comprising:
a foot insertion volume, where the foot insertion volume comprises a proximal part and a lateral part that extends from the proximal part and in a vertical direction upwards away from the proximal part;
a first layer having a lateral surface and a medial surface;
a waterproof and vapor permeable functional second layer having a lateral surface and a medial surface, where the second layer is positioned between the foot insertion volume and the medial surface of the first layer;
a sole assembly comprising an upper facing surface and a ground contacting surface, where the upper facing surface is connected to the proximal part of the upper assembly and where a peripheral part of the sole assembly overlaps a proximal part of the first layer and/or a proximal part of the second layer;
wherein the first layer of the upper assembly comprises textile having through-going openings extending from the lateral surface and towards the medial surface,
wherein a part of a sole material of the sole assembly penetrates the through-going openings, such that the sole material bonds to the second layer providing a waterproof seal between the sole material and the second layer at a position where the first layer abuts the second layer in the region where the peripheral part of the sole assembly overlaps the proximal part of the first layer and/or the second layer, and
wherein the through-going openings are formed by passages between interlocked strands of the textile.

2. The article of footwear in accordance with claim 1, wherein the second layer includes through-going openings, and
wherein the sole material penetrates the through-going openings in the second layer providing a waterproof inner seal on the medial surface of the second layer in order to ensure that liquids cannot enter or exit the foot insertion volume via the through-going openings in the second layer.

3. The article of footwear in accordance with claim 2, wherein the inner seal extends from the opening and in a distal direction along the medial side of the second layer, where the inner seal optionally extends from the opening and in a proximal direction along the proximal part of the foot insertion volume.

4. The article of footwear in accordance with claim 1, where the upper facing surface terminates in a lateral end (edge) that extends in a radial direction away from a central point of the sole assembly.

5. The article of footwear in accordance with claim 1, wherein the first layer and the second layer are attached to each other via at least one stitch.

6. The article of footwear in accordance with claim 1, where the upper assembly further comprises a connecting portion adapted to connect the proximal portion of the upper assembly to the first and/or the second layer.

7. The article of footwear in accordance with claim 1, where the connecting portion extends a distance in a radial direction outward from a central point of the upper assembly towards a radial part of the upper assembly, where the connecting portion overlaps the upper facing surface of the sole assembly in a lateral direction in a range between 50% and 99%.

8. The article of footwear in accordance with claim 1, wherein the sole material does not penetrate parts of the region between the first layer and the second layer in the region where the sole material overlaps the first layer and/or the second layer.

9. The article of footwear in accordance with claim 1, wherein the first layer is an outermost layer of the upper assembly.

10. The article of footwear in accordance with claim 1, wherein the sole assembly is injection molded.

11. The article of footwear in accordance with claim 1, wherein the sole material of the sole assembly is a polymer material, a polyurethane (PU), a thermoplastic polyurethane (TPU), or a multi component sole assembly comprising different parts of polymeric materials having different properties.

12. The article of footwear in accordance with claim 1, wherein the through-going openings include a plurality of through-going openings positioned on a proximal end of the first and/or the second layer.

13. The article of footwear in accordance with claim 12, wherein the plurality of through-going openings are arranged in a linear manner, creating one or more rows of through-going openings in the first and/or the second layer.

14. The article of footwear in accordance with claim 1, wherein the waterproof seal extends continuously along the entire proximal part of the second layer.

15. The article of footwear in accordance with claim 1, wherein the medial surface of the first layer abuts the lateral surface of the second layer in the region where the peripheral part of the sole assembly overlaps the proximal part of the first layer and/or proximal part of the second layer.

16. A method of manufacturing an article of footwear, the footwear including:
an upper assembly having a longitudinal axis extending from a heel area of the upper assembly towards the forefoot area of the upper assembly, the upper assembly comprising:
a foot insertion volume, where the foot insertion volume comprises a proximal part and a lateral part that extends from the proximal part and in a vertical direction upwards away from the proximal part,
a first layer having a lateral surface and a medial surface,
a waterproof and vapor permeable functional second layer having a lateral surface and a medial surface, where the second layer is positioned between the foot insertion volume and the medial surface of the first layer; and
a sole assembly comprising an upper facing surface and a ground contacting surface, where the upper facing surface is connected to the proximal part of the upper assembly and where a peripheral part of the sole assembly overlaps a proximal part of the first layer and/or the second layer,
where the first layer of the upper assembly comprises textile having through-going openings extending from the lateral surface and towards the medial surface; and
where the method comprises:
bonding, between the first layer and the second layer, by penetrating adhesive through the through-going openings onto the second layer thereby providing a waterproof seal between a sole material and the second layer, and
wherein the through-going openings are formed by passages between interlocked strands of the textile.

17. A method of manufacturing an article of footwear, the footwear including:
an upper assembly having a longitudinal axis extending from a heel area of the upper assembly towards the forefoot area of the upper assembly, the upper assembly comprising:
a foot insertion volume, where the foot insertion volume comprises a proximal part and a lateral part that extends from the proximal part and in a vertical direction upwards away from the proximal part,
a first layer having a lateral surface and a medial surface,
a waterproof and vapor permeable functional second layer having a lateral surface and a medial surface, where the second layer is positioned between the foot insertion volume and the medial surface of the first layer; and
a sole assembly comprising an upper facing surface and a ground contacting surface, where the upper facing surface is connected to the proximal part of the upper assembly and where a peripheral part of the sole assembly overlaps a proximal part of the first layer and/or the second layer,
where the first layer of the upper assembly comprises textile having through-going openings extending from the lateral surface and towards the medial surface; and
where the method comprises:
bonding, between the first layer and the second layer, by penetrating sole material through the openings onto the second layer thereby providing a waterproof seal between the sole material and the second layer,
wherein the through-going openings are formed by passages between interlocked strands of the textile.

18. The method of manufacturing an article of footwear according to claim 17, whereby the penetrating of sole material through said through-going openings is provided by a direct injection process of the sole material to the upper assembly.

19. The method of manufacturing an article of footwear according to claim 17, wherein the sole material is polyurethane

20. The method of manufacturing an article of footwear according to claim 17, wherein the through-going openings of the textile is at least partly provided by a perforation process performed on only a part of said first layer.
